(19) United States
(12) Patent Application Publication
(10) Pub. No.: US 2010/0064946 A1
(43) Pub. Date: Mar. 18, 2010

(54) MATERIAL HANDLING PLATFORM, COMPONENTS AND METHODS OF PRODUCTION THEREOF

(75) Inventor: Bruce Watson, Bunbury (W.A.) (AU)

Correspondence Address: VOLPE AND KOENIG, P.C., UNITED PLAZA, SUITE 1600, 30 SOUTH 17TH STREET, PHILADELPHIA, PA, 19103, US

(73) Assignee: CAS HOLDINGS AUSTRALIA PTY LTD, Bunbury (W.A.) (AU)

(21) Appl. No.: 12/529,301

(22) PCT Filed: Feb. 29, 2008
(86) PCT No.: PCT/AU08/00266

§ 371 Date: Oct. 30, 2009

(30) Foreign Application Priority Data
Mar. 1, 2007 (AU) 2007901053

(51) Int. Cl. B65D 19/38; B65D 19/32; B23P 11/00

(52) U.S. Cl. 108/57.25; 29/525.01

(57) ABSTRACT

A method of manufacturing a sheet material using fibreglass, such as glass fibres 802,803, fibre glass matting 801 and/or fibreglass webbing/tape 601, and polymer, such as polypropylene. The fibreglass is coated in liquid polymer and formed into sheet material 800, preferably by compression rollers 808,810. The material product is formed, by bending/folding, into desired shapes, such as box sections to form pallet/support platform sections. The formed sections can be fastened together, such as by elongate members passing through a series of aligned apertures between adjacent sections. The elongate members can be heat staked to the sections. Inserts can be used in the ends of the sections to provide additional rigidity and strength. Thus, a composite pallet/support platform can be manufactured in production line form.

### TECHNICAL FIELD

The present invention relates to material handling platforms or pallets for storage and transport of goods, such as pallets used in conjunction with forklift vehicles, and to component parts for such material handling platforms and methods of production thereof.

### BACKGROUND OF THE INVENTION

Traditionally pallets and like material handling platforms have been made of timber, though more recently, plastic, cardboard and even metal pallets have become popular. Timber pallets are considered to be relatively cheap to produce, though tend to have a short lifespan because they are prone to damage.

For example, timber pallets typically have two or three stringers supporting the load bearing upper planks, and typically the stringers will rest on a series of lower decking planks to provide additional rigidity and strength to the timber pallet. However, such timber pallets become damaged in use from impact by forklift trucks or against vertical racking or loading or transport impacts. Damaged timber pallets can be repaired but it is generally more cost effective to discard the damaged pallet and obtain a replacement.

Plastic and metal pallets overcome many of the drawbacks of timber pallets, and tend to be stronger and less prone to damage. Plastic pallets are usually made of a plastic resin, being lighter and more durable than timber pallets. Plastic pallets offer benefits over traditional timber pallets because they are resistant to absorbing liquids, and therefore less prone to odour or sanitization problems. Plastic pallets also work better than timber pallets for toxic materials. Plastic pallets are generally more expensive than timber pallets though have a longer expected service life. However, plastic pallets cannot easily be repaired when damaged, and therefore become discarded and of no further use for any application. Discarded plastic pallets are slow to degrade in rubbish heaps or landfill sites, and therefore become an environmental problem.

Cardboard or paper pallets have been adopted, typically for relatively light loads, though some more recent engineered cardboard pallets are increasingly used for loads that compare with timber pallets. Cardboard or paper pallets are also often adopted where recycling and easy disposal is required. However, such pallets are easily damaged, especially if exposed to wet weather or wet environments, leading to hazardous storage.

Metal pallets have been adopted for high load applications, or where the pallet may be subject to a risk of damage that other pallets would not sustain. However, it will be appreciated that metal pallets are costly to manufacture and require a high capital input for a business. Most types of business do not require metal pallets because timber or plastic pallets provide sufficient load capacity and are cheaper to produce and replace as required.

With the aforementioned in mind, one or more forms of the present invention seeks to provide improvements to material handling platforms such as pallets that alleviates at least one or more of the problems of the aforementioned prior art.

### SUMMARY OF THE INVENTION

With the aforementioned in mind, in one aspect the present invention provides a method for the production of a composite material, including the steps of:
a) extruding a plastics material;
b) coating fibres of a material with the plastics material to form a base composite product;
c) shaping the base product to a desired profile; and
d) pre-tensioning the base product by applying tension thereto; and
e) cooling the base product.

The product may be flattened e.g., by rollers during the process, to form a tape, web or sheet. Alternatively, the base product may be formed by accumulating together the coated fibres as a bundle to form an elongate member of substantial width and height compared to a sheet, web or tape. Preferably, the coated fibres may be fed into a heated accumulator or device of like function which collects all the coated fibres together to form the bundle.

The base product may be shaped through formers to mould and smooth the product. The product may then travel through cooling zone, preferably before final trimming to length.

A further aspect of the present invention provides a method for the production of a composite material, including the steps of:
a) combining polypropylene and glass fibre materials;
b) extruding and/or pultruding the combined polypropylene and glass fibre materials;
c) forming the combined materials into a sheet or web composite material.

Sheets and/or webs of the material may be laminated together. Advantageously the final laminated material provides a strong yet adaptable base material for use in the construction of composite material pallets. The laminated material is relatively light, tough and practical to form into required shapes or arrangements for construction into pallets.

Preferably the extruded and/or pultruded material is passed through rollers to expel residual trapped air, and may be trimmed to length and/or width.

The lamination process may include laminating two or more of the combined materials using guided rollers and vacuum suction onto a conveyor bed. These laminated materials may pass through a series of heaters, and finally cooled, e.g., by cooled rollers, which may be fitted with cutters to trim the final sheet or web to a required size.

Advantageously, one or more embodiments of the above process enables high volume manufacture of base laminated materials that are consistent and accurate. One or more embodiments also overcomes problems associated with laying up sheet or web materials from glass fibre and/or plastic tape, which otherwise allows for weaknesses in the seams and inconsistencies in the final product. In addition, one or more embodiments also overcomes problems associated with vacuum bagging techniques for the production of sheet materials. Vacuum bagging techniques are know to be very slow and inaccurate, with often poor and inconsistent results in removing air pockets from the product.

In a preferred form, the laminated material combines 60% glass fibre and 40% polypropylene, though it will be appreciated that these proportions may be varied.

A further aspect of the present invention provides a laminated material produced by a method of extruding and/or pultruding a base composite material of polypropylene and glass fibre materials, and preferably laminating at least two sheets or webs, preferably four or more, using rollers and vacuum suction onto a conveyor bed, heating and thereafter cooling the laminated material.

A still further aspect of the present invention provides a method for manufacturing a pallet, including the steps of:
a) providing a sheet of laminated polypropylene and glass fibre material;
b) forming a series of apertures through the sheet;
c) folding the sheet material to form a pallet section;
d) arranging together a number of said pallet sections to form a base pallet structure; and
e) connecting together the arranged base pallet sections with fasteners to form the pallet.

The aforementioned production method results in a relatively light yet strong composite pallet combing polypropylene and glass fibre materials. The connected sections provide rigidity yet can be readily replaced if damaged.

Preferably each laminated sheet is punched to form the series of apertures, which may be shaped to correspond to a cross-section of a fastener for connecting sections together.

The apertures may be formed by interference punching, whereby the sheet material is stretched and torn through by at least one tapered punch resulting in a clean edged aperture with minimal loose fibres. This process is preferably automated such that as one sheet is released from a punch device carrying out the punching, another sheet is automatically fed for punching.

Preferably, the punched sheets are then fed one after the other to a bending line.

The method of manufacture may include the steps of heating and bending each laminated sheet to a predetermined shape. For example, four laminated sheets may be heated and bent in series to each form one quarter of the pallet. Each sheet may be heated and bent to form one or more elongate box sections for strength and rigidity. Heating the laminated sheet material avoid cracking and splitting problems during bending.

Preferably the formed pallet sections are brought together and fastened together, preferably through the apertures. The fastening means may be provided by one or more elongate members arranged to pass through a series of the apertures thereby connecting the required pallet sections to form the final pallet. The fasteners may be mechanically inserted through the sections, such as by hydraulic drive, electrically actuated drive, or other mechanical drive.

The folded box section arrangement for each section may form what is effectively the stringers for the pallet. Additional inserts may be provided into one or more end openings of the box sections, and preferably fastened to the material of the respective section, to provide additional rigidity and strength. This particularly assists in avoiding sideways tilting or collapse of the composite pallet.

The elongate member or members may be “heat staked” to fit the respective elongate member to the material of the pallet. In addition, or alternatively, smaller fastening members may be utilised. These smaller fastening members may take the same or similar form as the elongate strengthening members, though it will be appreciated that they may be different.

The combined pallet sections may be placed on a staking line whereby the required elongate fastening members previously inserted through the pallet sections can be preheated and subsequently staked.

The pallet may include a non-slip material to the upper loading surface, additional feet for enhanced stability when loaded, and/or raised side edges (shoulders) to assist in retaining products on the pallet.

A further aspect of the present invention provides a method of manufacturing an elongate strengthening member for the composite pallet, including the steps of:
a) combining polypropylene and fibreglass materials; and
b) pultruding the polypropylene and fibreglass materials.

The resulting elongate member combines the benefits of polypropylene with those of fibreglass resulting in a strengthening member for composite pallets which is light and strong, yet resistant to weather degradation, rotting and is of low cost to produce.

The polypropylene may be extruded and combined with the fibreglass material, preferably through into an accumulator.

The combined polypropylene and fibreglass materials may be passed through a series of formers, and preferably into a cooling region to harden the material. Subsequently, during pultrusion the partially formed member may be pulled (pultruded) into a shaping device, such as a cuter, to profile the final cross-section of the elongate member.

Advantageously, the manufacturing process may utilize production machinery for the aforementioned laminated sheets. This may be achieved by replacing rollers used for forming the sheet material with a series of formers, cooling chamber and shaping devices. Thus, advantageously, the same machinery with minor adaptations may be used to manufacture, say, 1,200 mm wide laminated sheets or multiple lines of elongate members, with very little adaptation of the machinery.

Where other processes use a resin which is cold and chemically charged to produce the required profile of fastening member, the elongate fastening members of one or more forms of the present invention utilize polypropylene which is suitable for heat staking or heat bonding.

Another form of the present invention provides a method of manufacturing a sheet material product including fibreglass, the method including;
a) providing fibreglass matting between glass fibres either side thereof;
b) coating the fibreglass matting and the glass fibres with liquid polymer;
c) combining the coated fibreglass matting and glass fibres into a sheet material.

This method is advantageous for manufacturing a strong yet relatively light polymer (e.g. polypropylene) reinforced fibreglass sheet material suitable for reducing, preferably by cutting, into desired sheet sizes. Also, the resultant sheet material may be folded into required sizes and/or shapes yet retain or increase in structural strength.

The method may preferably include forming the sheet material with approximately 60% fibreglass matting and glass fibres, and 40% polymer (such as polypropylene).

Preferably the fibreglass matting is provided from a supply head between respective supply heads for each of the glass fibres. Preferably the glass fibres are provided as glass fibre strands. In a preferred embodiment, the glass fibre strands are provided by a respective upper and lower supply head with the glass fibre matting supply head positioned therebetween.

The glass fibres and/or the fibreglass matting may be passed through a bath of liquid polymer before or after being forwarded through the respective supply head.

The sheet material may be passed through one or more roller stages, and the polymer cooled to effect hardening. Cooling may be achieved by the use of cooled/chilled rollers, or may be cooled naturally for slower curing/hardening of the polymer. However, other cooling arrangements are considered to fall with the scope of the present invention, such as the use of air, such as cooled air, refrigeration, cooled beds, racking or transport/conveyor equipment.

Heated guides may be used to assist in forming/bending and/or transporting the sheet material.

A series of cooled rollers/roller stations may be used to harden/cure the sheet material. These are preferably progressive i.e. one after the other, but may be provided simultaneously to the sheet.

The method may be a continuous production method, such as by utilising apparatus to draw or push, or both, the fibre glass and matting, and thus the sheet material through the manufacturing stages. This may preferably be achieved by pullers for pulling the materials through the process stages.

The liquid polymer (such as polypropylene) coated fibreglass matting and glass fibres on eith side thereof may be compressed into the sheet material, preferably by rollers, such as cooled rollers, though heated or un-heated rollers may be used for integrating the materials together to form the initial sheet.

The above arrangement avoids the need to laminate webs or tapes of fibreglass together. Lamination, whilst effective and advantageous over some other manufacturing techniques, can be a time consuming process. The aforementioned manufacturing process using matting sandwiched between glass fibres is a more efficient manufacturing process, which can be continuous, thereby realising production efficiencies, whilst resulting in a rigid or formable sheet material depending on the final thickness, and of sufficiently high strength for use in forming containers, wall panels, and support items, such as pallet sections or whole pallets.

A further form of the present invention provides a composite sheet material product comprising polymer coated fibreglass matting sandwiched between polymer coated glass fibres.

Preferably the material product is formed, e.g. by folding or bending, and preferably before the polymer hardens, to a desired form such as a box section.

The polymer may be polypropylene, though other polymers are envisaged to fall within the scope of the invention.

A further form of the present invention provides a platform form supporting a load, such as a pallet, formed of at least one portion of composite sheet material product comprising polymer coated fibreglass matting sandwiched between polymer coated glass fibres. Preferably the platform includes two or more sections of the composite material shaped and fastened together to form a pallet having integral box sections. Fastening means may include one or more elongate members arranged to connect the sections together. The elongate member(s) may include retaining means to retain the sections together, and may pass through apertures in the sections.

It will be convenient to further describe the present invention with respect to the accompanying drawings, which illustrate preferred embodiments of the inventions. Other arrangements of the invention are possible, and consequently the particularity of the accompanying drawings is not to be understood as superseding the generality of the preceding description of the invention.

### BRIEF DESCRIPTION OF THE DRAWINGS

FIG. 1 shows a flow chart of the embodiment of the method of production of the laminated sheet.

FIG. 2 shows an embodiment of a method of production of the composite pallet.

FIG. 3 shows an embodiment of a method of production of an elongate fastening member.

FIG. 4 shows stages for production of a laminated sheet prior to bending to form a pallet section according to an embodiment of the present invention.

FIG. 5 shows stages in performing and assembling pallet sections according to an embodiment of the present invention.

FIG. 6 shows stages in production of web material used to subsequently form the laminated sheets according to an embodiment of the present invention.

FIG. 7 shows stages in production of the elongate member used for connecting together pallet sections according to en embodiment of the present invention.

FIG. 8 depicts production steps for manufacturing sheet material according to an embodiment of the present invention. The material is subsequently formed into box sections, and two or more sections joined together to form a platform/pallet.

FIG. 9 shows a section of a pallet formed according to an embodiment of the present invention.

### DESCRIPTION OF PREFERRED EMBODIMENT

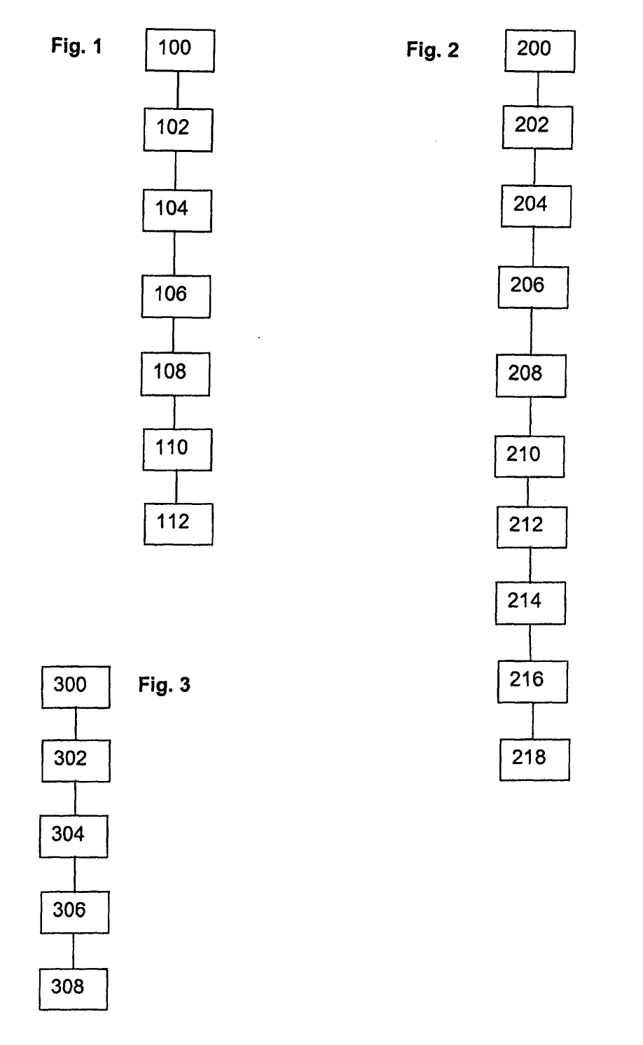

Referring to FIG. 1, the first manufacturing step 100 involves the extrusion and pultrusion of a 1,200 mm wide sheet of combined polypropylene and fibreglass material. This process involves a head which combines the polypropylene and glass fibre squeezed 102 through rollers. Subsequently, the sheet travels 104 through three cooled rollers to expel any trapped air, and finally is pulled 106 and cut to length. Typically the final sheet will be 1,200 mm wide×800 mm long.

The lamination process involves laying four of the aforementioned sheets together, preferably with the “grain” of the lamination running in alternate directions, i.e., first sheet with the grain up and down, second with the grain side to side, third sheet with the grain up and down again, fourth sheet with the grain side to side again. The four sheets are laid 108 using guided rollers and vacuum suction onto a conveyor bed. The conveyor bed passes 110 the laminations through a series of heaters, and subsequently passes 112 the heated sheets into cooled rollers fitted with cutters to trim the final sheets to size. Each trimmed sheet is approximately 1,200 mm×800 mm, through it will be appreciated that other sizes are envisaged and fall within the scope of the present invention. The aforementioned process overcomes known problems with laying up of sheet material from roll tape, which inherently introduces weaknesses in the seams, introduces air pockets, and results in an inconsistent product.

Referring to FIG. 2, the base laminated sheets are interference punched 200 using a series of eight punches. The sheets are subsequently fed 202 from the front of the punch device using grippers controlled by a linear actuator. Each sheet is fed at predetermined distances, and the punches are pushed through the sheet using air pressure to a predetermined depth. Each punch has a tapered point such that the glass fibre in the sheet is stretched and torn, resulting in an aperture with clean edges and no loose fibres. The process continues until all forty-eight holes are punched through each sheet. The sheet is then released 204 out of the back of the punch device and another is automatically fed 200 into the front of the punch device. Following punching, the sheet are stacked in a pile, picked up with a forklift and placed at the beginning of the bending line on a hydraulically driven lifter.

Sheets are consecutively taken 206 by vacuum cups and placed into the beginning of the line. The sheets are chain driven 208 down the line over a series of ten heaters and benders, which shape the sheet and form one quarter of the pallet. The heating and bending process forms each sheet into a box section stringer and a box section strengthening member running along the length of each sheet. Four of these sheets are turned back to back 210 and placed into the insertion machine where eight elongate fastening members are hydraulically inserted through the four sections.

A preferred form of the invention utilizes injection molded inserts placed into the ends of each box section stringer. These may be retained in place by heat staking the elongate strengthening members. The assembled pallet is then placed 214 on the staking line and computer driven to the heat staking bay where all the protruding elongate strengthening members are heated 216. The pallet is then passed 218 onto the final stage for staking, whereby the elongate strengthening members are heat staked to the pallet section.

It will be appreciated that the inserts may also be heat staked into position, and may alternatively or additionally include smaller elongate strengthening members to retain and strengthen those inserts in place.

It will be appreciated that the completed pallet may include end caps for closing the end of one or more of the box section stringers or elongate strengthening box sections, which can assist in preventing dirt and debris gathering within those box sections, which alleviates risk of fire and infestation. In addition, the number of elongate strengthening members can be reduced for light weight pallets for low load capacity applications. Furthermore, the smaller elongate strengthening members and/or full length strengthening members can be reduced in number or size for low load capacity applications. Each pallet may be provided with additional feet for stability and non-slip applications. Non-slip surface material may be provided on the upper surface of each pallet and/or each pallet may include upstanding side shoulders to retain products on the top surface.

The extruded and pultruded product can be manufactured using 60% glass fibre and 40% polypropylene by weight. The polypropylene is heated, melted and extruded via an extruder. The molten polypropylene is fed into an aluminium head or bath through which 50-80 “cheeses” of glass fibre run, depending on the width and density of the desired product. These “cheeses” are situated in rows on rotating rollers to reduce or eliminate twist in the glass which is introduced when manufactured. The twist is eliminated to allow for increased fibre spread when entering the bath in order to ensure sufficient coating of the polypropylene.

This process permits manufacturing of either tape, sheet or elongate product (such as dogbone) depending on what product is required. To make the “wet out”, fibres are run through horizontal water cooled rollers, which sit on top of each other and pressure mounted which spreads the product out to the necessary width of tape. The tape then travels down the line where a series of hydraulic pullers grab the tape and continuously pull it through (pultrusion). This part of the process also applies tension to the glass fibres at the head, and the resultant product is a pre-tensioned tape which is simply cut to the desired length.

To make the elongate member e.g., for staking the pallet sections together, after the product comes out of the bath it runs into a heated accumulator which collects all the coated fibres and allows them to escape in the rough shape of the member (e.g., dogbone). It then travels through teflon formers which mold and smooth the product, before finally travelling through an air-conditioned curtain to cool allowing again the pullers to pull the product continuously before being cut to the desired length.

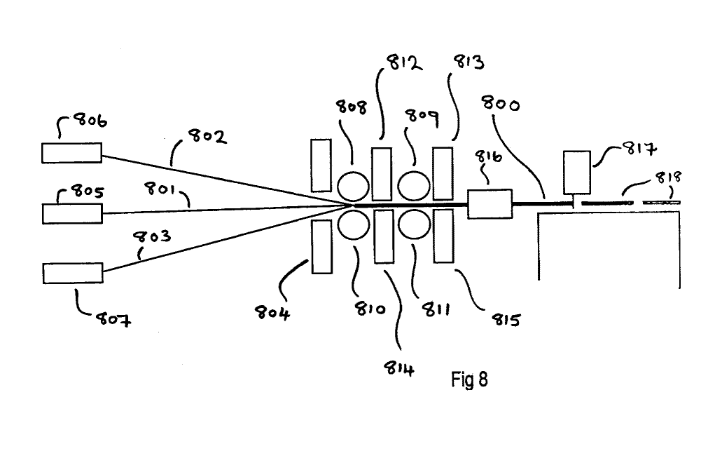

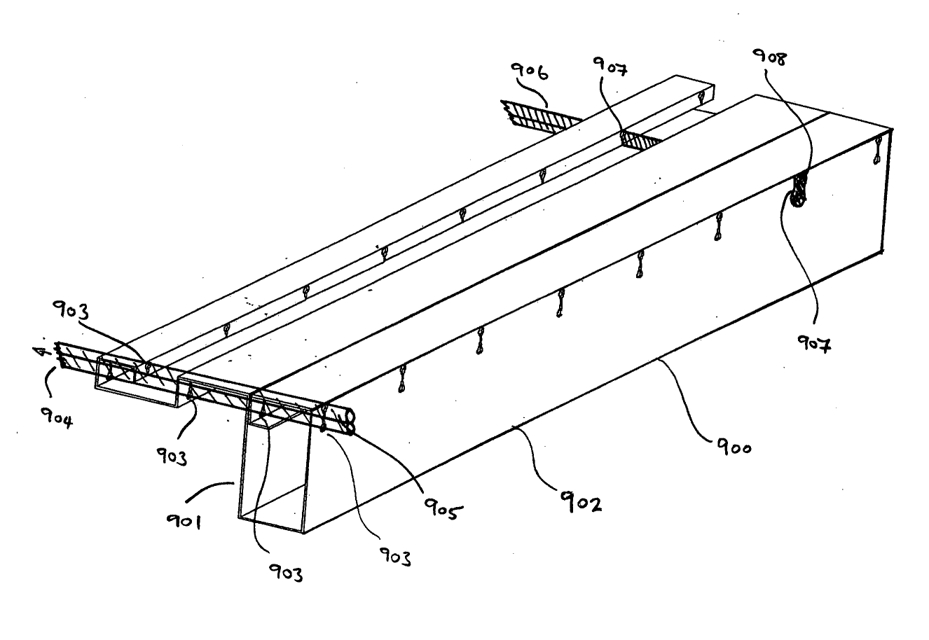

As shown in the diagrammatic style figure, FIG. 8, sheet material product 800 can alternatively be manufactured by providing fibreglass matting 801 between upper 802 and a lower 803 glass fibres; coating the fibreglass matting and the upper and lower glass fibres with liquid polypropylene. In this embodiment a bath of liquid polypropylene is used to coat the glass fibres and matting, and in this case, the heads act as the baths for to effect the coating. These are combined into the sheet material product 800. This can include forming the sheet material with approximately 60% fibreglass matting and glass fibres, and 40% polypropylene. In this embodiment, the fibreglass matting is provided from a supply head 805 between respective supply heads 806, 807 for each of the glass fibres. The glass fibres are provided as glass fibre strands, though it will be appreciated that other elongate glass fibre materials may be used, such as thread. It will be appreciated that the glass fibres and/or the fibreglass matting can be passed through a bath of liquid polypropylene before or after being forwarded through the respective supply head. However, it has been found expedient to coat the fibres and/or matting within the respective heads. The sheet material product being formed can then be passed through one or more roller stages 804 to compress the materials together, and the polypropylene cooled to effect hardening. Cooling can be achieved by the use of cooled/chilled rollers 809, 811, or can be by natural cooling for slower curing/hardening of the polypropylene. Roller stages can be provided that act as either or both of compression or cooling stages 808, 810. However, other cooling arrangements are considered to fall with the scope of the present invention, such as the use of air, such as cooled air, refrigeration, cooled beds, racking or transport/conveyor equipment.

Heated guides 812, 813, 814, 815 are used to assist in forming/bending and/or transporting the sheet material.

The method can be a continuous production method, such as by utilising apparatus 816 to draw or push, or both, the fibre glass and matting, and thus the sheet material through the manufacturing stages. This can be achieved by pullers 816 for pulling the materials through the process stages.

The above arrangement avoids the need to laminate webs or tapes of fibreglass together. Lamination, whilst effective and advantageous over some other manufacturing techniques, can be a time consuming process. The aforementioned manufacturing process using matting sandwiched between glass fibres is a more efficient manufacturing process, which can be continuous, thereby realising production efficiencies, whilst resulting in a rigid or formable sheet material depending on the final thickness, and of sufficiently high strength for use in forming containers, wall panels, and support items, such as pallet sections or whole pallets.

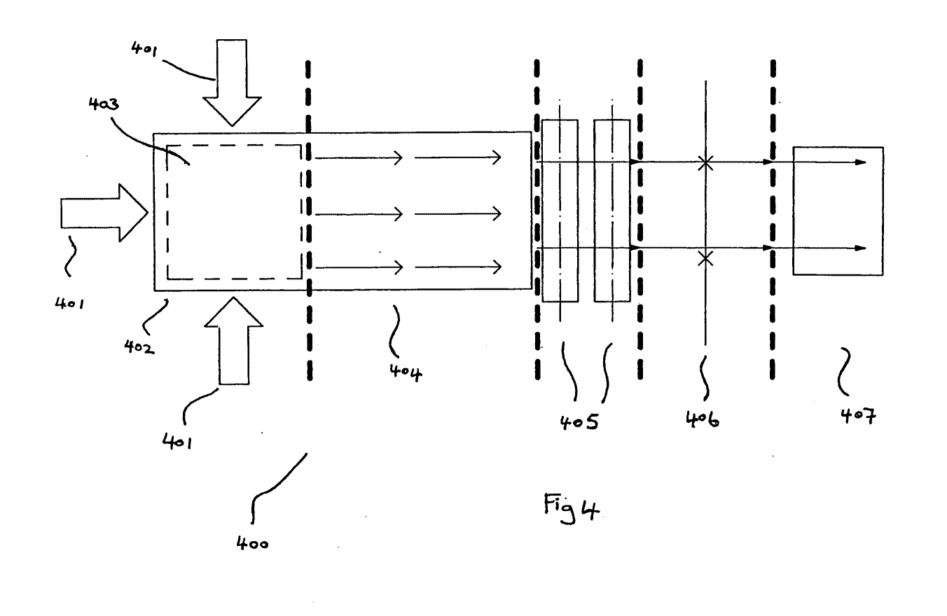

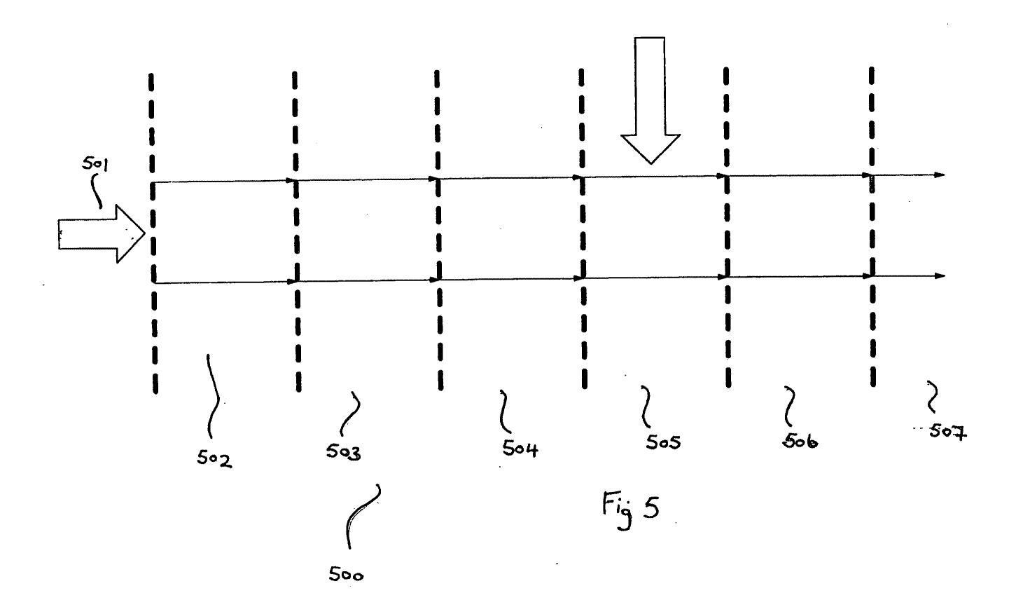

The material product 800 can then be severed/cut into required sized sections 818 by severing apparatus 817. Referring to FIG. 3, production of the elongate strengthening member can use the same machinery as used for producing the laminated sheets, previously explained. This is a key advantage to overall production of the final pallet, whereby the base laminated sheet material and the elongate strengthening members can be produced on much the same machinery with minor adaptations.

For example, polypropylene material can be extruded 300 into a head and passed 302 with the glass fibre through into an accumulator. The combined extruded polypropylene and glass fibre material is then passed 304 through a series of formers, and thereafter passed 306 into a long cooling chamber. The cooled elongate member is then pulled 308 into a cutter profiled with a D-bone (dog bone) cross section. Thus, the present machinery for producing components of the present invention can advantageously be used to make either the 1,200 mm wide laminated sheets or multiple lines of the elongate strengthening member (D-bone) with very little adaptation required.

Thus, the polypropylene and glass fibre material can be produced by extrusion and pultrusion, compared with known processes which use a resin which is cold and chemically charged to produce the profile required.

The resulting pallet alleviates problems of extremely heavy pallets, typically of timber, which splinter resulting in stock damage and wastage. The majority of the pallet market utilises timber pallets, and there was foreseen a need for a relatively light weight but very strong pallet as a replacement. Traditional replacement plastic pallets have inherent problems, in particular, “creep” which occurs over time where plastic pallets begin to lean under the weight of the load or through repeated use, eventually leading to collapse. To the contrary, the pallet and pallet components of one or more embodiments of the present invention exhibits resiliency arising from the use of pre-tensioned glass fibre, which allows the product to return to its initial position, even after periods of substantial loading.

Furthermore, know plastic pallets are also relatively heavy, consistent with timber pallets, and cannot normally withstand extremes of temperature. For example, plastic pallets tend to become brittle in freezing temperature.

Furthermore, the addition of inserts into the end openings of the box section stringers provides additional rigidity and strength, which further aids in resisting “creep” or leaning of the pallet.

In addition, should one or more of the pallet sections become damaged in use, for example by forklift damage or mishandling, the heat staking can be reheated to melt the polypropylene and release the elongate strengthening members as required. The damaged section or all sections can then be replaced with new sections, and the combination of old and new sections refastened together, preferably with new elongate strengthening members.

in order to assist in reducing abrasive damage to the underside of the stringers in contact with the ground, especially rough concrete or gravel surfaces, additional feet can be provided. These may also be used to add stability to the pallet.

It will be appreciated that damaged sections removed from the pallet can be discarded or recycled, and the remaining good sections reintroduced to the manufacturing process, along with any new pallet sections as required. Thereafter, a remanufactured pallet returns from the normal manufacturing production line.

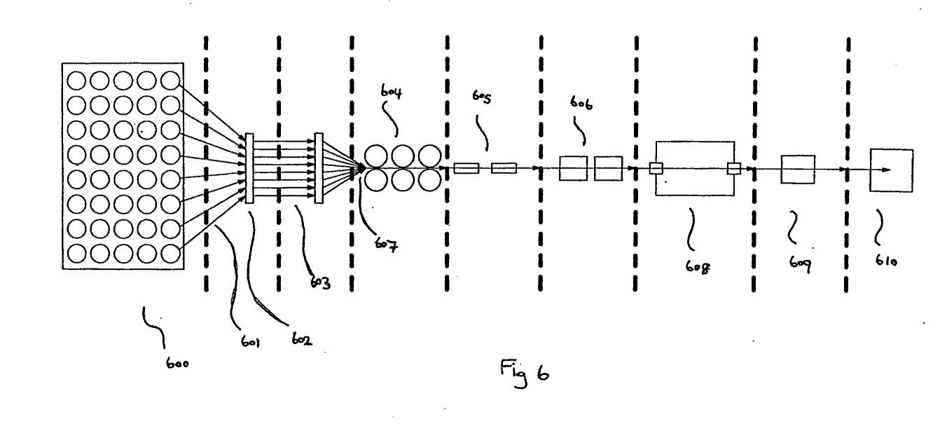

Stages in the production of components and a composite pallet according to one or more embodiments of the present invention will hereinafter be described with reference to FIGS. 4 to 7.

FIG. 4 shows a consolidation bed 400 for forming a laminated sheet for use as a section of a composite pallet. Polypropylene and fibreglass web material 401 is overlaid on a forming bed 402 to produce an initial sheet material 403, this is then forwarded and heated over a heated conveyor 404 stage, and subsequently compressed e.g., via pinch rollers 405. The laminated sheet material is thus formed and then trimmed to size via a docking saw stage 406 and then the laminated sheet is forwarded to a hole punching stage 407 whereby a requisite number of holes at predetermined positions are punched through the laminated material e.g., by an interference punch prior to bending of the sheet to form a finished pallet section.

FIG. 5 shows the subsequent bending line stages 500, whereby supply of the laminated sheet material 501 is fed in and heated at a pre-bending stage 502. Reverse bends 503 are then formed in each laminated sheet 501 prior to forward bending 504 to form the final basic pallet section including the pre-punched staking holes. This forms, in one particular embodiment, a quarter pallet section. Thus, in at least one embodiment, four of the quarter pallet sections are brought together and “staked” at an elongate member insertion line stage 505 through the aligned apertures between the sections. The elongate members are then heat staked at the ends thereof to consolidate and rigidize at a staking line section 506 prior to the final basic pallet being output 507.

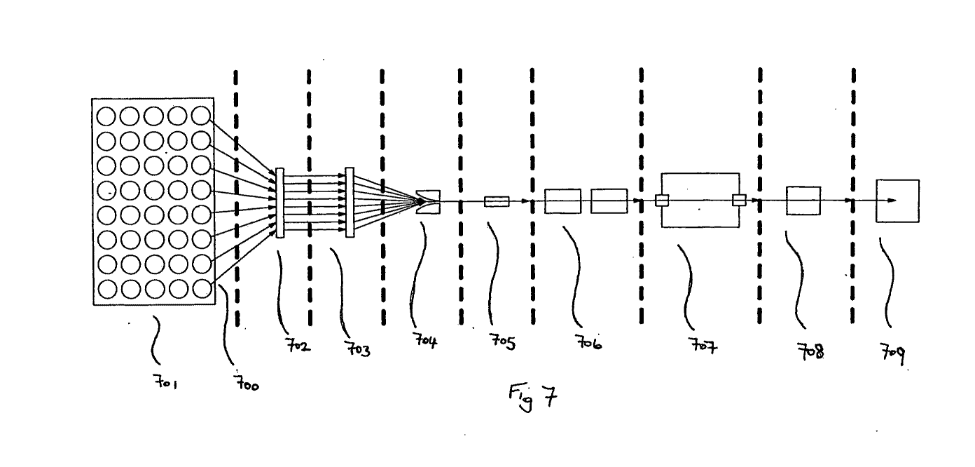

FIG. 6 shows stages for the production of wet material used for forming the laminated sheet. Fibreglass threads 601 are drawn from a thread wheel stand 600 through a thread guide 602. The threads are coated with polypropylene in a coating bath 603 prior to being brought together and compressed together at a roll forming stage 604 which applies pressure to consolidate and form a basic web. The basic web thereafter travels through a non-stick former station 605 to further form the final web prior to passing through a cooling bath stage 606. The filaments of the web material pass through an extruder 607 prior to the roll forming stage 604, and are also tensioned by a pultruder stage 608. Thus, the final web material undergoes extrusion and pultrusion during its manufacture, resulting in a more even and consolidated product, with reduced risk of irregularities or air bubbles within the web. This leads to a stronger more uniform web material of polypropylene coated glass fibre. After the pultruder stage 608, the web material is trimmed to size at a docking saw section 609 before being output as a final product 610.

FIG. 7 shows manufacturing stages for the elongate member used for staking the pallet sections together. It will be appreciated that, in this embodiment, the manufacturing stages are similar to those for manufacturing the web material for the laminated sheet material; however, the polypropylene coated glass fibre threads are compressed together at an accumulator stage to form the basic elongate compressed member material. Thus, following the steps of FIG. 7, glass fibre threads 700 are drawn from a thread reel stand 701 through a thread guide stage 702 and coated with polypropylene in a coating bath stage 703. The coated threads are thereafter consolidated at an accumulator 704 prior to being drawn through a non-stick former stage 705 and thereafter passing through a cooling bath stage 706. The elongate member material is drawn by a pultruder stage 707 as well as extruded at or prior to the accumulator stage 704. Thus, a pre-tensioned elongate member is formed which is also consolidated to a solid material of substantial solid cross-section at the accumulator. The elongate member material is trimmed to size at a docking saw stage 708 prior to output 709.

FIG. 9 shows a section 900 of a pallet according to an embodiment of the present invention utilising a folded 901 composite sheet material 902. The material is formed by laminating fibre glass and glass fibres together whilst coated with liquid polypropylene, and then hardening the polypropylene, such as by cooled rollers. The materials can be compressed together by pinch rollers. The sheet material is folded before or after the polypropylene is hardened, preferably before for ease of bending. A number of the sections (only one is shown) are joined together, such as through aligned apertures 903, by an elongate member 904. The elongate member is shown in phantom as an example of the type of fastening means. The ends of the elongate member can be staked eg by heat melting the ends thereof 905 to secure the sections together. A portion of another similar elongate member 906 is shown passing through aligned apertures 907 and staked at one end thereof 908. It will be appreciated that 4 such sections joined back to back in pairs and the pairs joined together, all by a series of the elongate members, such as dogbone members, which can also be formed of fibreglass and polymer composite materials, can be used to form a sturdy, cost effective pallet of high load bearing capacity for its weight, whilst being cost effective to produce and repairable.

It will thus be appreciated that the production line for manufacturing the web material and the production line for manufacturing the elongate member are substantially the same with few modifications. The main differences being the addition of an accumulator to consolidate the polypropylene coated glass fibre material at the accumulator for manufacturing the elongate member.

1-11. (canceled)

12. A method for manufacturing a pallet, including the steps of:
providing a sheet of laminated polypropylene and glass fibre material;
forming a series of apertures through the sheet;
folding the sheet material to form a pallet section; and
connecting together a plurality of base pallet sections with fasteners to form the pallet.

13-26. (canceled)

27. A method according to claim 12, further comprising;
a) providing fibreglass matting between glass fibres either side thereof;
b) coating the fibreglass matting and the glass fibres with liquid polymer;
c) combining the coated fibreglass matting and glass fibres to form the sheet material.

28. The method according to claim 27 including forming the sheet material with approximately 60% fibreglass matting and glass fibres, and 40% polymer

29. The method according to claim 28, including providing the fibre glass matting from a supply head between respective supply heads for each of the glass fibres.

30. (canceled)

31. The method according to claim 27, further comprising providing the glass fibre strands or threads via a respective upper and lower supply head with the glass fibre matting supply head positioned therebetween.

32. The method according to claim 27 further comprising coating the glass fibres and/or the fibreglass matting with liquid polypropylene before, during or after being forwarded through the respective supply head.

33. The method according to claim 27, further comprising forwarding the sheet material relative to one or more roller stages, and cooling the polymer or polypropylene.

34-40. (canceled)

41. A method according to claim 12, wherein the series of apertures is arranged to correspond to a cross-section of a fastener for connecting sections of the product together.

42. A method according to claim 12, wherein the apertures are formed by interference punching whereby the sheet material is stretched and torn through by at least one tapered punch resulting in a clean edged aperture with minimal loose fibres.

43. A method according to claim 42, further comprising punching or cutting the apertures, such as by high pressure water cutting.

44. A method according to claim 12, further comprising heating and bending each laminated sheet to a predetermined shape.

45. (canceled)

46. A method according to claim 12, wherein the sheets are connected together to form a pallet using elongate member arranged to pass through a series of the apertures.

47. A method according to claim 12, further comprising providing an insert into one or more end openings of the box sections to provide additional rigidity and strength.

48. A method according to claim 46 further comprising heat staking the at least one elongate member to fit the respective elongate member to the material of the pallet.

49. (canceled)

50. A method according to claim 46, wherein the at least one elongate fastening member is preheated and subsequently staked.

51-55. (canceled)

56. A platform for supporting a load, the platform comprising at least one portion of composite sheet material product comprising polymer coated fibreglass matting sandwiched between polymer coated glass fibres.

57. A platform according to claim 56 wherein two or more sections of the composite material are shaped and fastened together by a fastener to form a pallet having integral box sections.

58. A platform according to claim 57, wherein the fastener includes at least one elongate member arranged to connect the sections together.

59. A platform according to claim 58, wherein the at least one elongate member includes a retainer to retain the sections together.

60. A platform according to claim 59, wherein the at least one elongate member passes through apertures in the sections.
